(19) United States
(12) Patent Application Publication
(10) Pub. No.: US 2025/0059410 A1
(43) Pub. Date: Feb. 20, 2025

(54) PRESSURE SENSITIVE ADHESIVE CONTAINING LIQUID RESIN COMPRISING AN OLIGOESTER COMPOSITION

(71) Applicant: Henkel AG & Co. KGaA, Düsseldorf (DE)

(72) Inventors: Benjamin Brammertz, Erkrath (DE); Barbora Lanova, Düsseldorf (DE); Adrian Brandt, Essen (DE)

(21) Appl. No.: 18/937,348

(22) Filed: Nov. 5, 2024

Related U.S. Application Data
(63) Continuation of application No. PCT/EP2023/062692, filed on May 11, 2023.

(30) Foreign Application Priority Data
May 12, 2022 (EP) 22172937.9

(51) Int. Cl. C09J 7/38; C09J 153/00

(52) U.S. Cl. CPC C09J 7/387; C09J 153/00; C09J 2203/334; C09J 2301/414; C09J 2423/00; C09J 2453/00; C09J 2491/00

(57) ABSTRACT

The present invention relates to a pressure-sensitive adhesive composition containing at least one polymer, at least one liquid resin comprising an oligoester composition as described herein and at least one further plasticizer, wherein the at least one further plasticizer comprises an isobutene/butene copolymer. The invention also relates to the use of the pressure-sensitive adhesive composition according to the invention, to a method for preparing the pressure-sensitive adhesive composition, and to a method for bonding at least two substrates. Finally, the invention relates to an article comprising the pressure-sensitive adhesive composition according to the invention.

The present invention relates to a pressure-sensitive adhesive composition containing at least one polymer, at least one liquid resin comprising an oligoester composition as described herein and at least one further plasticizer, wherein the at least one further plasticizer comprises an isobutene/butene copolymer. The invention also relates to the use of the pressure-sensitive adhesive composition according to the invention, to a method for preparing the pressure-sensitive adhesive composition, and to a method for bonding at least two substrates. Finally, the invention relates to an article comprising the pressure-sensitive adhesive composition according to the invention.

For reasons of sustainability and growing environmental awareness, it is desirable to increasingly replace mineral-oil-based compounds with substances based on renewable raw materials.

Commercially available pressure-sensitive adhesive compositions typically contain plasticizers based on mineral oils. It is advantageous to reduce as much as possible or completely avoid the use of these substances, especially in food packaging, but also in hygiene articles, for example, and in many other fields, for example to prevent migration from the adhesive into the packaging material. There is therefore a need for substitutes that can partially or completely replace these plasticizers and are suitable and approved for contact with food.

Many of the available alternatives based on renewable raw materials are disadvantageous in terms of compatibility with the other components of the pressure-sensitive adhesive composition and/or lead to a drop in performance with regard to the adhesive characteristics of the adhesive composition.

Therefore, the object of the present invention is to provide a pressure-sensitive adhesive composition which has the highest possible proportion of renewable resources in the formulation, in particular by largely replacing the mineral-oil-based plasticizers previously used. At the same time, such a composition should have the same or even improved performance in terms of adhesive strength and stability in comparison with conventional systems and should also be suitable, for example, for the production of food packaging or hygiene articles, i.e., should contain only constituents that are approved for contact with food.

Surprisingly, it has been found that this object is achieved by a pressure-sensitive adhesive composition which, in addition to at least one polymer, comprises a combination of at least one liquid resin and at least one further plasticizer, wherein the at least one further plasticizer comprises or consists of an isobutene/butene copolymer and the liquid resin comprises an oligoester composition, wherein the oligoester composition is a reaction product of a reaction mixture comprising:
ii) one or more monocarboxylic acids, optionally in an amount of at least 15 wt. %, based on the total weight of the reaction mixture;
iii) one or more polyhydric alcohols; and
iv) optionally one or more polycarboxylic acids,
wherein the reaction mixture comprises one or more colophonies.

The liquid resin described, in combination with the isobutene/butene copolymer, replaces at least partially, preferably even completely, the typically used mineral-oil-based plasticizers, in particular naphthenic oils and/or paraffinic oils, in the pressure-sensitive adhesive composition, and is thus a sustainable alternative to mineral-oil-based plasticizers. Preferably, such pressure-sensitive adhesive compositions comprising the liquid resin and the isobutene/butene copolymer described herein exhibit improved adhesive strength and/or adherence to various substrates.

A first aspect of the invention therefore relates to a pressure-sensitive adhesive composition comprising:
a) at least one polymer;
b) at least one liquid resin comprising an oligoester composition, which is a reaction product of a reaction mixture, comprising:
   ii) one or more monocarboxylic acids, optionally in an amount of at least 15 wt. % based on the total weight of the reaction mixture;
   iii) one or more polyhydric alcohols; and
   iv) optionally one or more polycarboxylic acids;
   wherein the reaction mixture comprises one or more colophonies;
c) at least one further plasticizer, wherein the at least one further plasticizer comprises an isobutene/butene copolymer;
d) optionally at least one further resin; and
e) optionally at least one additive, preferably at least one stabilizer.

The pressure-sensitive adhesive composition according to the invention preferably comprises at least one polymer a) selected from the group of polymers based on acrylate, polyester, urethane, ethylene acrylate, butyl rubber and (synthetic) (natural) rubber; ethylene-vinyl acetate copolymers (EVA), polyolefin (co)polymers (PO), polyamide (co)polymers (PA), ethylene-propylene copolymers or styrene copolymers, individually or as a mixture, said polymer particularly preferably being a styrene block copolymer, such as a styrene and styrene-butadiene copolymer (SBC, SBS, SBR), a styrene-isoprene copolymer (SIS), a styrene-ethylene/butylene copolymer (SEBS), a styrene-ethylene/propylene-styrene copolymer (SEPS) or a styrene-isoprene-butylene copolymer (SIBS), or a mixture thereof.

Particularly preferably, the at least one polymer a) is a styrene-isoprene copolymer (SIS), a styrene-butadiene copolymer (SBC) and/or an ethylene-vinyl acetate copolymer (EVA) or a mixture thereof, in particular a styrene-butadiene copolymer (SBC).

Particularly preferably, the polymer a) is contained in the pressure-sensitive adhesive composition in an amount of 10 to 70 wt. %, preferably 15 to 70 wt. %, more preferably 20 to 70 wt. %, for example 20 to 50 wt. %, 20 to 40 wt. % or 25 to 60 wt. %, based on the total weight of the pressure-sensitive adhesive composition.

Another essential constituent of the compositions according to the invention is the liquid resin b), which comprises an oligoester composition as described herein. In various embodiments, the reaction mixture for preparing the oligoester composition comprises at least 15 wt. % of one or more monocarboxylic acids, one or more polyhydric alcohols, and
optionally more than 0 wt. % to less than 4 wt. % of one or more polycarboxylic acids, wherein the reaction mixture comprises one or more colophonies. In various embodiments, however, the one or more monocarboxylic acids can also be used in an amount of 14 wt. %.

Preferably, the reaction mixture for preparing the oligoester composition comprises 25 wt. % to 85 wt. % of one or more monocarboxylic acids, 7 wt. % to 35 wt. % of one or more polyhydric alcohols, and optionally more than 0 wt. % to less than 4 wt. % of one or more polycarboxylic acids, wherein the reaction mixture preferably comprises 5 wt. % to 75 wt. % colophony.

Typically, colophony comprises a mixture of colophony acids, preferably C20 tricyclic monocarboxylic acids and isomers thereof, more preferably tricyclic diterpene carboxylic acids. Suitable colophony acids can be selected from the group consisting of abietic acid, neoabietic acid, dehydroabietic acid, dihydroabietic acid, pimaric acid, levopimaric acid, sandaracopimaric acid, isopimaric acid and palustric acid and their isomers, without being limited thereto.

In various embodiments, the liquid resin b) consists of the described oligoester composition. “Liquid resin” as used herein means that this constituent is in liquid form at standard conditions, i.e., 20° C. and 1013 mbar.

Particularly preferably, the at least one liquid resin b) is contained in the pressure-sensitive adhesive composition in an amount of 1 to 50 wt. %, more preferably of 2 to 40 wt. %, even more preferably of 5 to 40 wt. %, in particular of 5 to 30 wt. %, based in each case on the total weight of the pressure-sensitive adhesive composition.

Suitable liquid resins are commercially available, for example from Kraton Corporation. A detailed manufacturing specification, without being limited thereto, can be found, for example, in the specification US 2017/0190935 A1. The liquid resins or oligoester compositions described therein are suitable for use as component b) in the pressure-sensitive adhesive composition described herein. The whole of this document is hereby incorporated by way of reference.

According to the invention, the pressure-sensitive adhesive composition comprises a combination of at least one liquid resin b) as described herein and at least one further plasticizer c), wherein the at least one plasticizer comprises or consists of an isobutene/butene copolymer. A pressure-sensitive adhesive composition of this kind preferably has a comparable to increased adhesive strength and/or adherence to various substrates (e.g., steel, polyethylene, non-woven fabric, glass or cardboard) in comparison with reference adhesives.

Preferably, the at least one further plasticizer c) or the isobutene/butene copolymer is used in an amount of 0.1 to 30 wt. %, more preferably 1 to 15 wt. %, in particular 5 to 12 wt. %, based on the total weight of the pressure-sensitive adhesive composition. Further preferably, this further plasticizer c) or the isobutene/butene copolymer has a number-average molecular weight Mn of 750-1450 g/mol, more preferably 850-1350 g/mol, in particular 900-1300 g/mol, measured by size-exclusion chromatography (GPC: gel permeation chromatography). In various embodiments, the at least one further plasticizer c) or the isobutene/butene copolymer can have a glass transition temperature (Tg) of −60 to −73° C., more preferably −63 to −73° C., in particular −66 to −70° C., preferably measured by dynamic differential thermal analysis (DSC: differential scanning calorimetry). The plasticizer c) or the copolymer can also have a kinematic viscosity of 0.00018-0.0007 m2/s (180 to 700 cSt), preferably 0.00019 to 0.00067 m2/s (190 to 670 cSt), in particular 0.0002 to 0.000655 m2/s (200 cSt-655 cSt), determined at 100° C. according to the method described in ASTM D445.

Particularly preferably, the at least one liquid resin b) and the at least one further plasticizer c) together have a concentration in the pressure-sensitive adhesive composition of 5 to 50 wt. %, preferably 10 to 40 wt. %, in particular 15 to 35 wt. %, based on the total weight of the components of the pressure-sensitive adhesive composition.

Furthermore, it is particularly preferred for the pressure-sensitive adhesive composition according to the invention to comprise no further plasticizers besides the isobutene/butene copolymer, i.e., to be free of further plasticizers.

Preferably, the described liquid resin b) in combination with the further plasticizer c) can partially or preferably completely replace conventional mineral-oil-based plasticizers, in particular naphthenic oils and/or (white medical) paraffinic oils.

As a result, the pressure-sensitive adhesive composition according to the invention comprises, in various preferred embodiments, mineral-oil-based plasticizers, in particular naphthenic oils and/or paraffinic oils, at less than 10 wt. %, more preferably less than 9 wt. %, even more preferably less than 8 wt. %, even more preferably less than 7 wt. %, even more preferably less than 6 wt. %, even more preferably less than 5 wt. %, even more preferably less than 4 wt. %, even more preferably less than 3 wt. %, even more preferably less than 2 wt. %, even more preferably less than 1 wt. %, even more preferably less than 0.5 wt. %, even more preferably less than 0.1 wt. %, even more preferably less than 0.01 wt. %, most preferably it is free of these, based on the total weight of the composition.

In a preferred embodiment, the mineral-oil-based plasticizer or plasticizers, more preferably naphthenic oils and/or paraffinic oils, is or are replaced in the pressure-sensitive adhesive composition by the described liquid resin b) in combination with the further plasticizer c) which comprises an isobutylene-butene copolymer, to a degree of at least 50%, more preferably at least 60%, even more preferably at least 70%, even more preferably at least 80%, even more preferably at least 90%, even more preferably at least 95%, even more preferably at least 98%, even more preferably at least 99%, and most preferably 100%.

Furthermore, the pressure-sensitive adhesive composition can comprise at least one further resin d), which is preferably a natural resin or a hydrocarbon resin, more preferably a tall oil ester, gum rosin (colophony ester), an optionally partially polymerized tall resin, a terpene or a crude oil-based aliphatic, aromatic or cycloaliphatic hydrocarbon resin having, for example, 1 to 30 carbon atoms in the case of aliphatic and, for example, 6 to 30 carbon atoms in the case of aromatic and cycloaliphatic hydrocarbon resins, wherein the resins, as well as modified or hydrogenated versions thereof, can be, for example, C5-aliphatic or C9-aromatic hydrocarbon resin or a C5/C9 monomer mixture, wherein the resin differs from the liquid resin b), in particular is not a liquid resin but a solid resin. Such a “solid resin” is solid under standard conditions.

In various embodiments, the at least one further resin d) can comprise at least two resins, wherein the resins are preferably selected from (cyclo)aliphatic hydrocarbons and/or colophony esters, for example pentaerythritol esters.

In various embodiments, the resin d) is a solid resin, for example in pellet or pastille form. However, it can also be a solid resin which is then provided in melted form in a heated tanker truck, for example.

In particularly preferred embodiments, the further resin d) is contained in the pressure-sensitive adhesive composition in an amount of 10 to 70 wt. %, preferably 15 to 60 wt. %, for example 20 to 50 wt. %, 15 to 45 wt. % or 25 to 60 wt. %, based on the total weight of the composition.

In preferred embodiments, the pressure-sensitive adhesive composition according to the invention contains at least one additive e), which is preferably selected from the group consisting of antioxidants, such as stabilizers, waxes, UV protectors, solvents, adhesion promoters, fillers, pigments, flame retardants, UV absorbers, optical brighteners and fragrances, in particular stabilizers.

In various embodiments, the pressure-sensitive adhesive composition contains the at least one additive e) in an amount of 0.01 to 20 wt. %, preferably 0.1 to 5 wt. %, more preferably 0.5 to 3 wt. %, based on the total weight of the composition.

Further preferably, the pressure-sensitive adhesive according to the invention has increased adhesion to various substrates, for example steel or plastic. As a result, significantly less adhesive can be used to meet the requirements of the application in comparison with reference adhesives, for example the application weight can be reduced.

In a further aspect, the invention relates to a method for preparing the pressure-sensitive adhesive composition according to the invention, comprising mixing at least one liquid resin b) comprising an oligoester composition as described herein with further components of the pressure-sensitive adhesive composition, such as the at least one polymer a), the at least one plasticizer c) and optionally further components, such as at least one further resin d) and/or at least one additive e), in a suitable order; preferably at a temperature of 100 to 200° C., more preferably at 120 to 180° C., even more preferably 150 to 170° C.

In a further aspect, the invention relates to the use of the pressure-sensitive adhesive composition according to the invention in
adhesive tapes,
labels,
multi-layer films, e.g., for seals,
hygiene articles, e.g., diapers,
labeling, e.g., of beverage bottles,
flexible packaging,
food packaging,
cardboard boxes or envelopes,
in medical applications, e.g., in packaging for medical materials and products,
in the field of assembly (high performance, such as in the automotive industry), and/or
in the graphics industry (e.g., books, magazines, brochures).

Further examples include the coating of self-adhesive films. In general, the compositions described herein are suitable for film applications, i.e., self-adhesive films, tapes or labels.

In a further aspect, the invention relates to an article comprising the pressure-sensitive adhesive composition according to the invention.

The invention finally relates to a method for bonding at least two substrates, wherein the pressure-sensitive composition according to the invention is applied to at least one substrate and the at least two substrates are subsequently joined together.

In a preferred embodiment, the amount of pressure-sensitive adhesive composition applied is 1 to 200 g/m2, preferably 2 to 70 g/m2, more preferably 10 to 60 g/m2, for example 20 to 50 g/m2.

These and other embodiments, features and advantages of the invention will become apparent to a person skilled in the art through studying the following detailed description and claims. In this case, individual described features or embodiments of the invention can be combined with other features or embodiments of the invention without these having been described in combination within the scope of the invention. It is self-evident that the examples herein are intended to describe and illustrate the invention, but do not limit the invention, and in particular the invention is not restricted to the examples.

“At least one,” as used herein, refers to 1 or more, for example 2, 3, 4, 5, 6, 7, 8, 9 or more. In connection with the polymers described herein, this statement refers not to the absolute amount of molecules, but rather to the type of compound. “At least one polymer” therefore means, for example, that only one type of polymer or a plurality of different types of polymer can be contained without specifying the amount of the individual compounds.

Unless otherwise indicated, all amounts indicated in connection with the pressure-sensitive adhesive composition described herein refer to wt. %, in each case based on the total weight of the composition. Furthermore, such quantity specifications, which relate to at least one constituent, always refer to the total amount of this type of constituent contained in the composition, unless explicitly stated otherwise. This means that these amounts, for example in the context of “at least one polymer,” relate to the total amount of polymer contained in the composition, unless explicitly indicated otherwise.

Numerical values specified herein without decimal places refer in each case to the full specified value with one decimal place. For example, “99%” stands for “99.0%”.

Numerical ranges indicated in the format “in/from x to y” include the stated values. If several preferred numerical ranges are specified in this format, it is readily understood that any ranges resulting from the combination of the various endpoints are also included.

“About” or “approximately,” as used herein in relation to numerical values, means the corresponding value ±10%, preferably ±5%, in particular ±1%.

When reference is made herein to molar masses, this refers to the number-average molar mass Mn, unless explicitly indicated otherwise. The number-average molar mass can, for example, be determined by gel permeation chromatography (GPC) according to DIN 55672-1:2007-08 with THE as the eluent. The weight-average molar mass Mw can also be determined by means of GPC, as described for Mn. Suitable methods for determining Mn or Mw are also described, for example, in US 2017/0190935 A1.

In a first aspect, the invention relates to a pressure-sensitive adhesive composition comprising
a) at least one polymer;
b) at least one liquid resin comprising an oligoester composition, which is a reaction product of a reaction mixture, comprising:
   ii) one or more monocarboxylic acids, optionally in an amount of at least 15 wt. % based on the total weight of the reaction mixture;
   iii) one or more polyhydric alcohols; and
   iv) optionally one or more polycarboxylic acids;
   wherein the reaction mixture comprises one or more colophonies;
c) at least one further plasticizer, wherein the at least one further plasticizer comprises or consists of an isobutene/butene copolymer;
d) optionally at least one further resin; and
e) optionally at least one additive, preferably at least one stabilizer.

The pressure-sensitive adhesive composition is preferably a hot-melt pressure-sensitive adhesive composition (HMPSA). More preferably, the pressure-sensitive adhesive composition is a non-reactive pressure-sensitive adhesive composition, in particular a non-reactive hot-melt pressure-sensitive adhesive composition.

A “pressure-sensitive adhesive” is a typical representative of a non-curing adhesive. “Hot-melt pressure-sensitive adhesives” (HMPSA) are generally understood to be adhesives that are solid at room temperature and are, in particular, water- and solvent-free. They are typically applied to the parts to be bonded from the melt and, after joining, set physically while cooling and solidifying. Such hot-melt pressure-sensitive adhesives preferably remain permanently tacky and adhesive when cooled and immediately adhere to almost all substrates under slight contact pressure.

“Non-reactive” or “physically setting” in this context typically means that the solidification takes place in a physical process (e.g., by hardening on cooling, or by evaporation of solvents or water).

The pressure-sensitive adhesive composition according to the invention contains at least one polymer a). This can be a homopolymer or a copolymer.

Examples of such polymers include, but are not limited to, polymers based on acrylate, polyester, urethane, ethylene acrylate, butyl rubber and (synthetic) natural rubber; ethylene-vinyl acetate copolymers (EVA), polyolefin (co)polymers (PO), polyamide (co)polymer (PA), ethylene-propylene copolymers or styrene copolymers, individually or as a mixture, the copolymers typically being random, alternating graft or block copolymers. Thermoplastic elastomers are preferably selected from the group of styrene block copolymers, for example styrene and styrene-butadiene copolymers (SBC or SBS, SBR), styrene-isoprene copolymers (SIS), styrene-ethylene/butylene copolymers (SEBS), styrene-ethylene/propylene-styrene copolymers (SEPS) or styrene-isoprene-butylene copolymers (SIBS). Such products are known to a person skilled in the art and are commercially available.

Particularly preferably, the at least one polymer a) is a styrene block copolymer, such as styrene-isoprene-styrene (SIS), styrene-butadiene-styrene (SBS), or styrene-ethylene-butadiene-styrene (SEBS), more preferably a styrene-isoprene-styrene triblock copolymer or a styrene-butadiene copolymer (SBC) or a mixture thereof.

In various embodiments, the pressure-sensitive adhesive composition according to the invention can also contain an ethylene-vinyl acetate copolymer (EVA), which can also be used in addition to those mentioned above.

In a preferred embodiment, the at least one polymer a) is contained in the pressure-sensitive adhesive composition in an amount of 10 to 70 wt. %, preferably 15 to 70 wt. %, more preferably 20 to 70 wt. %, for example 20 to 50 wt. %, 20 to 40 wt. %, 25 to 60 wt. %, 30 to 60 wt. % or 28 to 40 wt. %, based on the total weight of the composition.

Furthermore, the pressure-sensitive adhesive composition contains at least one liquid resin b) comprising an oligoester composition which is a reaction product of a reaction mixture comprising:
ii) one or more monocarboxylic acids;
iii) one or more polyhydric alcohols; and
iv) optionally one or more polycarboxylic acids,
wherein the reaction mixture comprises one or more colophonies.

In various embodiments, the reaction mixture for preparing the oligoester composition comprises at least 15 wt. % of one or more monocarboxylic acids, based on the total weight of the reaction mixture. In other embodiments, however, the one or more monocarboxylic acids can also be used in an amount of 14 wt. %.

“Liquid resin” describes any resin composition that can be prepared from the reaction mixture described above and is liquid, i.e., flowable, at 20° C. and 1013 mbar. The liquid resin can in particular also comprise (highly) viscous resin compositions.

An oligoester composition of the described liquid resin b) can comprise, consist of or substantially consist of the oligoesters described herein. In one embodiment, the oligoester composition comprises from 1 weight percent (wt. %) to 100 wt. % of one or more oligoesters of the type described herein, based on the total weight of the composition, for example from 10 wt. % to 100 wt. %, from 20 wt. % to 80 wt. %, or from 30 wt. % to 70 wt. %. In some embodiments, the oligoester composition comprises equal to or less than 20 wt. % of a non-oligoester, based on the weight of the oligoester composition, for example less than 10 wt. % or less than 5 wt. %. The oligoester compositions can have improved color (e.g., the oligoester can have a pure Gardner color of 7 or less), improved oxidation stability (e.g., the oligoester composition can have an oxidation induction time at 110° C. of at least 30 minutes), improved color stability (e.g., the oligoester can have less than a 10% change in pure Gardner color when heated to a temperature of 160° C. for a period of three hours), or combinations thereof.

In the context of the present invention, “substantially” means that the compositions can contain further substances or compounds which, however, are not actively added to the oligoester composition, but are included due to, for example, impurities or undesirable side reactions. These additional constituents that go beyond the “substantial” constituents can preferably make up a weight proportion of less than 1 wt. %, preferably less than 0.1 wt. % or less than 0.01 wt. %, in each case based on the total weight of the oligoester composition.

The oligoester composition of the liquid resin b) described herein can be derived from at least one colophony.

Colophony, also called colophony or Greek pitch (Pix graeca), is a solid hydrocarbon secretion of plants, typically conifers, such as pines (e.g., Pinus palustris and Pinus caribaea). Colophony can contain a mixture of colophony acids, although the exact composition of the colophony depends partly on the plant species. Colophony acids are C20 condensed-ring monocarboxylic acids whose core consists of three condensed six-carbon rings containing double bonds that vary in number and position.

Suitable colophony acids are, for example but not limited to, abietic acid, neoabietic acid, dehydroabietic acid, dihydroabietic acid, pimaric acid, levopimaric acid, sandaracopimaric acid, isopimaric acid and palustric acid and their isomers. In various embodiments, natural colophony comprises primarily a mixture of the colophony acids abietic acid and/or pimaric acid.

Colophony is commercially available and can be obtained from pine trees by distillation of oleoresin (gum colophony is the residue of distillation), by extraction from pine stumps (wood colophony), or by fractionation of tall oil (tall oil colophony). Any type of colophony can be used to prepare the oligoester compositions described herein, including tall oil colophony, gum colophony, and wood colophony, and mixtures thereof. If desired, the colophony can be subjected to one or more purification steps (e.g., distillation under reduced pressure, extraction and/or crystallization) prior to its use as colophony in the esterification steps described herein. Hydrogenated colophony resins and partially hydrogenated colophony resins can also be used as a colophony source. An example of a commercially available hydrogenated colophony suitable for use in the present disclosure is FORAL™ AX-E, sold by Eastman Chemical Company. Examples of commercially available hydrogenated colophony include STAYBELITE™ Resin-E, marketed by Eastman Chemical Company, and HYDROGAL™, marketed by DRT (Dérivés Résiniques et Terpéniques).

In various embodiments, the described oligoester is obtained from tall oil colophony (TOR). Non-limiting examples of commercially available TOR include SYLVAROS™ 90S, SYLVAROS™ HYR, SYLVAROS™ NCY, SYLVAROS™ 85S, SYLVAROS™ 90F and SYLVAROS™ R Type S, which are commercially available from Arizona Chemical, a subsidiary of Kraton Corporation.

Crude tall oil (CTO), as obtained from the kraft paper pulping process, contains significant amounts of TOR and tall oil fatty acid (TOFA). Distilled tall oil (DTO) is an industrial refinery product obtained from the fractional distillation of crude tall oil. DTO mainly contains TOR and TOFA (a mixture of several monocarboxylic acids). In some embodiments, DTO can be used as a starting point for preparing the described oligoester composition. Several commercial DTO grades with varying colophony contents are sold as the SYLVATAL™ product line by Arizona Chemical, a subsidiary of Kraton Corporation, including SYLVATAL™ 10S, SYLVATAL™ 20/25S, SYLVATAL™ 20S, SYLVATAL™ 25/30S, SYLVATAL™ D25 LR, SYLVATAL™ D30 LR and SYLVATAL™ D40 LR.

In preferred embodiments, the oligoester composition is derived from 5 wt. % to 80 wt. %, for example 10 to 70 wt. % or 30 to 60 wt. %, colophony, based on the total weight of the components used to prepare the oligoester composition.

As described above, colophony contains a mixture of colophony acids (e.g., abietadienoic acids), which can contain conjugated double bonds in their ring systems. These conjugated double bonds can be a source of oxidative instability. Accordingly, in some embodiments, the colophony, oligoester, or combinations thereof are processed to reduce the percentage of components containing conjugated double bonds. The term “PAN number” as used herein refers in particular to the sum of the weight percent of the palustric acid, abietic acid and neoabietic acid components as obtained by hydrolysis from the oligoester, determined according to the method described in ASTM D5974-00 (2010).

In some embodiments, the oligoester can be derived from a colophony having a low PAN number. In some embodiments, the colophony obtained from the oligoester by hydrolysis can have a PAN number, determined according to the method described in ASTM D5974-00 (2010), of equal to or less than 25, for example equal to or less than 15 or equal to or less than 5. The colophony obtained from the oligoester by hydrolysis can contain equal to or more than 30 wt. % dehydroabietic acid, for example 30 to 60 wt. % or 40 to 55 wt. %, based on the total weight of the colophony. In some embodiments, the weight ratio of dehydroabietic acid to dihydroabietic acid in the colophony as obtained from the oligoester by hydrolysis is between 1:0.80 and 1:0.25, for example between 1:0.70 and 1:0.35, or alternatively between 1:0.55 and 1:0.40.

The oligoester composition described herein can further be derived from one or more polyhydric alcohols.

In various embodiments, the oligoester composition is derived from 5 to 40 wt. %, for example 5 to 30 wt. % or 9 to 18 wt. % or 9.7 to 12.7 wt. %, polyhydric alcohols, based on the total weight of the components used to prepare the oligoester composition.

The at least one polyhydric alcohol can comprise all suitable polyhydric alcohols. In various embodiments, the one or more polyhydric alcohols can have an average hydroxyl functionality of from 2 to 10, for example from 2 to 7 or from 3 to 5.

In specific embodiments, the one or more polyhydric alcohols comprise 2 to 36, for example 2 to 20 or 2 to 8, carbon atoms. For example, the one or more polyhydric alcohols can have a boiling point of more than 240° C. at about 1013 mbar (1 atm).

Polyhydric alcohols can contain a combination of linear, branched, cyclic aliphatic, partially unsaturated or aromatic chemical units and can optionally contain one or more additional functional groups in addition to the two or more hydroxyl units, such as an alkyl (e.g., C1-3 alkyl), aryl (e.g., benzyl), alkoxy (e.g., methoxy), haloalkyl (e.g., trifluoromethyl) or keto group. In aromatic polyhydric alcohols, the aromatic ring can optionally contain one or more ring substituents, such as a fluoro, chloro, alkyl (e.g., methyl or ethyl), methoxy or trifluoromethyl group. If desired, the one or more polyhydric alcohols can further contain one or more heteroatoms (e.g., one or more oxygen, sulfur or nitrogen atoms) incorporated into the molecular structure, such as an ether group in the case of incorporation of an oxygen atom or a thioether in the case of incorporation of a sulfur atom. In various embodiments, the one or more polyhydric alcohols comprise an aliphatic alcohol, e.g., a cycloaliphatic alcohol.

In some embodiments, the one or more polyhydric alcohols can comprise a polyol comprising a first hydroxyl group separated from a second hydroxyl group by 2 to 10 carbon atoms, alternatively by 2 to 7 carbon atoms, or alternatively by 3 to 5 carbon atoms. In some embodiments, the one or more polyhydric alcohols comprise a polyol in which each hydroxyl group of the polyol is separated from the other hydroxyl group of the polyol by at least 2 carbon atoms, for example by at least 3 carbon atoms or at least 6 carbon atoms.

Examples of suitable polyhydric alcohols include, but are not limited to, ethylene glycol, propylene glycol, diethylene glycol, triethylene glycol, tetraethylene glycol, neopentyl glycol, trimethylene glycol, glycerol, trimethylolpropane, trimethylolethane, pentaerythritol, technical grade pentaerythritol, dipentaerythritol, tripentaerythritol, 1,4-cyclohexanediol, polyethylene glycol, polyglycerol, technical grade polyglycerol, polyglycerol-3, polyglycerol-4, cyclohexane-1,4-dimethanol, tricyclo[5.2.1.0(2.6)]decane-4,8-dimethanol, hydrogenated bisphenol A (4,4′-isopropylidenedicyclohexanol), mannitol, sorbitol, xylitol, maltitol, and lactitol. In specific embodiments, the one or more polyhydric alcohols can be selected from diethylene glycol, triethylene glycol, glycerol, trimethylolpropane, pentaerythritol, technical grade pentaerythritol, dipentaerythritol, polyglycerol, polyglycerol-4, tricyclo[5.2.1.0(2.6)]decane-4,8-dimethanol, cyclohexane-1,4-dimethanol, hydrogenated bisphenol A (4,4′-isopropylidenedicyclohexanol), and combinations thereof.

The oligoester composition described herein can be derived from one or more monocarboxylic acids.

In various embodiments, the oligoester composition can be derived from 15 to 90 wt. %, for example 30 to 80 wt. % or 40 to 75 wt. %, of one or more monocarboxylic acids, based on the total weight of the components used to prepare the oligoester composition.

This can be any suitable carboxylic acid. Non-limiting examples of suitable monocarboxylic acids include aromatic monofunctional carboxylic acids, heteroaromatic monofunctional carboxylic acids, aliphatic monofunctional carboxylic acids, unsaturated linear or branched monofunctional carboxylic acids, partially unsaturated linear or branched monofunctional carboxylic acids, cycloaliphatic monofunctional carboxylic acids, partially unsaturated cyclic monofunctional carboxylic acids, natural fatty acids, synthetic fatty acids, fatty acids derived from vegetable oils and animal oils, and combinations thereof.

In some embodiments, the at least one monocarboxylic acid(s) can contain at least six carbon atoms, for example 6-36 carbon atoms, 6-32 carbon atoms, 6-25 carbon atoms, 6-22 carbon atoms, 6-18 carbon atoms, or 6-12 carbon atoms. Monocarboxylic acids can contain a combination of linear, branched, cyclic aliphatic (cycloaliphatic), partially unsaturated or aromatic or heteroaromatic chemical groups and can optionally contain one or more additional functional groups in addition to the carboxylic acid group, such as a hydroxyl, alkyl (e.g., C1-3 alkyl), aryl (e.g., benzyl), alkoxy (e.g., methoxy), haloalkyl (e.g., trifluoromethyl) or a keto group. In aromatic monocarboxylic acids, the aromatic ring can optionally contain one or more ring substituents, such as a fluoro, chloro, alkyl (e.g., methyl or ethyl), methoxy or trifluoromethyl group. If desired, the one or more monocarboxylic acids can further contain one or more heteroatoms (e.g., one or more oxygen, sulfur, or nitrogen atoms) incorporated into the molecular structure of the carboxylic acid, such as an ether group in the case of incorporation of an oxygen atom or a thioether in the case of incorporation of a sulfur atom.

Examples of suitable aliphatic monocarboxylic acids include, but are not limited to, formic acid, acetic acid, propionic acid, butyric acid, valeric acid, caproic acid, ethanoic acid, caprylic acid, pelargonic acid, capric acid, lauric acid, myristic acid, palmitic acid, stearic acid, arachidic acid, behenic acid, and cerotic acid. An example of a suitable aromatic monocarboxylic acid is benzoic acid. Non-limiting examples of suitable cycloaliphatic monocarboxylic acids are cyclopropanecarboxylic acid, cyclopentanecarboxylic acid and cyclohexanecarboxylic acid. Non-limiting examples of suitable unsaturated linear or branched monocarboxylic acids are linoleic acid, alpha-linolenic acid, elaidic acid, sapienic acid, arachidonic acid, myristoleic acid, palmitoleic acid and oleic acid. Suitable fatty acids obtained from vegetable oils (e.g., triglyceride vegetable oils) and animal fats and oils include palm oil, linseed oil, rapeseed oil, sunflower seed oil, olive oil, tung oil, peanut oil, cottonseed oil, palm kernel oil, soybean oil, corn oil, grapeseed oil, hazelnut oil, rice bran oil, safflower oil, sesame oil, butterfat and coconut oil. These fatty acids include linoleic acid, alpha-linolenic acid, palmitic acid, stearic acid, myristic acid and oleic acid. Non-limiting examples of natural fatty acids are tall oil fatty acid and its commercial products, such as isostearic acid.

In various embodiments, the at least one monocarboxylic acid can comprise oleic acid, linoleic acid, alpha-linolenic acid, palmitic acid, stearic acid, or combinations thereof. In specific embodiments, the at least one monocarboxylic acid can contain a tall oil fatty acid (TOFA). Suitable commercially available TOFA-derived monocarboxylic acids include, but are not limited to, part of the CENTURY™ product line sold by Arizona Chemical, a subsidiary of Kraton Corporation, such as CENTURY™ D1, CENTURY™ MO5, CENTURY™ MO5N, and isostearic acid products such as CENTURY™ 1105 and CENTURY™ 1107.

Carboxylic acids and their derivatives can be characterized by their iodine number. In specific embodiments, the at least one monocarboxylic acid(s) can have an iodine value of less than 275 mg/g, optionally less than 180 mg/g, or less than 115 mg/g, or less than 80 mg/g, or optionally from 55 mg/g to 270 mg/g, or from 60 mg/g to 250 mg/g, or from 70 mg/g to 200 mg/g, as determined by the method described in ASTM D5768-02 (2014).

Particularly preferably, the at least one monocarboxylic acid is a fatty acid, a tall oil fatty acid or a mixture thereof.

In various embodiments, the oligoester composition can optionally be further derived from one or more polycarboxylic acids.

The oligoester compositions can be derived from less than Q wt. % of one or more polycarboxylic acids, where Q is defined by the following formula

$$10 - 2 ( \begin{matrix}{\sum }_{{polycarboxylic}_{acids}} & {( XY )}_{\text{?}}\end{matrix} )$$

$$\text{?} \text{indicates text missing or illegible when filed}$$

where Σ denotes the mathematical summation of the product of X and Y for each of the one or more polycarboxylic acids; X is the carboxylic acid functionality of the polycarboxylic acid and is an integer in the range of 2 to 4; and Y is the polycarboxylic acid weight fraction of the polycarboxylic acid and is in the range of 0 to 1, where the sum of the weight fractions for the one or more polycarboxylic acids is equal to 1. In other words, the Q value refers to the percentage of polycarboxylic acids in the total ester composition. For example, using 50 wt. % of a dicarboxylic acid and 50 wt. % of a tricarboxylic acid would result in a Q value of 10−2(2×0.5+3×0.5)=10−2(1+1.5)=10−2×2.5=5%. Analogously, the use of only dicarboxylic acid would result in a Q value of 6%. In some embodiments, Q can be defined by the following formula

$$8 - 2 ( \begin{matrix}{\sum }_{{polycarboxylic}_{acids}} & {( XY )}_{\text{?}}\end{matrix} )$$

$$\text{?} \text{indicates text missing or illegible when filed}$$

where Σ denotes the mathematical summation of the product of X and Y for each of the one or more polycarboxylic acids; X is the carboxylic acid functionality of the polycarboxylic acid and is an integer in the range of 2 to 4; and Y is the polycarboxylic acid weight fraction of the polycarboxylic acid and is in the range of 0 to 1, where the sum of the weight fractions for the one or more polycarboxylic acids is equal to 1.

In various embodiments, the oligoester composition can be derived from 0 to 4 wt. %, for example from 0 to 3 wt. % or from 0 to 2 wt. %, polycarboxylic acids (i.e., 2 or more carboxylic acid functionalities), based on the total weight of the components used to prepare the oligoester composition.

In specific embodiments, the oligoester can be derived from 0 to 6 wt. %, optionally from 0 to 4 wt. % or from 0 to 2 wt. %, of one or more dicarboxylic acids (i.e., 2 carboxylic acid functionalities), based on the total weight of the components used to form the liquid resin b). In various embodiments, the oligoester composition is not derived from any polycarboxylic acid.

The at least one polycarboxylic acid can comprise all suitable polycarboxylic acids. In some embodiments, the one or more polycarboxylic acids can comprise a dicarboxylic acid; in some embodiments, the one or more polycarboxylic acids can comprise a tricarboxylic acid. In some embodiments, the one or more polycarboxylic acids can be a tetracarboxylic acid. In some embodiments, the one or more polycarboxylic acids comprise 2 to 54 carbon atoms, for example 4-35 carbon atoms or 6-12 carbon atoms.

Polycarboxylic acids can contain a combination of linear, branched, cyclic aliphatic (cycloaliphatic), unsaturated, partially unsaturated, heteroaromatic or aromatic chemical units and can optionally contain one or more additional functional groups in addition to the two or more carboxylic acid units, such as a hydroxyl, alkyl (e.g., C1-3 alkyl), aryl (e.g., benzyl), alkoxy (e.g., methoxy), haloalkyl (e.g., trifluoromethyl) or a keto group. In aromatic polycarboxylic acids, the aromatic ring can optionally contain one or more ring substituents, such as a fluoro, chloro, alkyl (e.g., methyl or ethyl), methoxy or trifluoromethyl group. If desired, the one or more polycarboxylic acids can further contain one or more heteroatoms (e.g., one or more oxygen, sulfur or nitrogen atoms) incorporated into the molecular structure, such as an ether group in the case of incorporation of an oxygen atom or a thioether in the case of incorporation of a sulfur atom.

Non-limiting examples of suitable polycarboxylic acids include adipic acid, 3-methyladipic acid, succinic acid, sebacic acid, 1,4-cyclohexanedicarboxylic acid, 1,3-cyclohexanedicarboxylic acid, 1,2-cyclohexanedicarboxylic acid, colophony dimer, isophthalic acid, terephthalic acid, phthalic acid, TOFA dimer, hydrogenated TOFA dimer, 2-(2-carboxyphenyl)benzoic acid, 2,5-furandicarboxylic acid, camphoric acid, cis-norbornene-endo-2,3-dicarboxylic acid, trimellitic acid, and combinations thereof. UNIDYME™ 30 is an example of a commercially available dimerized TOFA derivative suitable for use in the present disclosure.

The ratio of the weight of one or more polycarboxylic acids to the weight of the colophony and the one or more monocarboxylic acids can be less than 1:20, for example less than 1:50 or less than 1:100. In various embodiments, the weight ratio between the colophony and the one or more monocarboxylic acids can be between 60:40 and 10:85. The ratio of the weight of the colophony and the one or more monocarboxylic acids to the weight of the one or more polycarboxylic acids can be at least 6.5:1 or at least 15:1. In specific embodiments, the oligoester composition can be derived, for example, from 30 wt. % to 75 wt. % colophony, or from 25 wt. % to 60 wt. % of one or more monocarboxylic acids, or from 5 wt. % to 18 wt. % of one or more polyhydric alcohols; or from 0 wt. % to less than 4 wt. % of one or more polycarboxylic acids.

In one embodiment, the oligoester composition can be derived from 5 to 75 wt. % colophony, 15 to 85 wt. % of one or more monocarboxylic acids, or alternatively from 7 wt. % to 40 wt. % of one or more polyhydric alcohols, or from 0 to less than 4 wt. % of one or more polycarboxylic acids. In one embodiment, the oligoester composition can be derived from 15 to 75 wt. % colophony, from 36 to 80 wt. % of one or more monocarboxylic acids, from 9 to 35 wt. % of one or more polyhydric alcohols, and from 0 to less than 4 wt. % of one or more polycarboxylic acids. In one embodiment, the oligoester composition can be derived from 30 to 75 wt. % colophony, 25 to 60 wt. % of one or more monocarboxylic acids, 3 to 18 wt. % of one or more polyhydric alcohols and 0 to less than 4 wt. % of one or more polycarboxylic acids. In one embodiment, the oligoester composition can be derived from 5 to 75 wt. % colophony, from 15 to 85 wt. % of one or more monocarboxylic acids, from 7 to 40 wt. % of one or more polyhydric alcohols and from 0 to less than 6 wt. % of one or more dicarboxylic acids, the dicarboxylic acid containing 2 to 35 carbon atoms.

Particularly preferably, the reaction mixture for preparing the oligoester composition comprises:
ii) 25 wt. % to 85 wt. % of one or more monocarboxylic acids,
iii) 7 wt. % to 35 wt. % of one or more polyhydric alcohols, and
iv) optionally from more than 0 wt. % to less than 4 wt. % of one or more polycarboxylic acids, based on the total weight of the reactants used in the reaction mixture,
   wherein the reaction mixture preferably comprises 5 wt. % to 75 wt. % colophony.

In various embodiments, the oligoester composition described herein has a weight-average molecular weight Mw from 500 g/mol to 8000 g/mol, for example from 700 g/mol to 8000 g/mol, from 1000 to 5000 g/mol or from 1100 g/mol to 3000 g/mol, measured by gel permeation chromatography (GPC) according to ASTM D5296-05. In specific embodiments, less than 35 wt. %, for example less than 20 wt. % or less than 13 wt. % of the oligoester composition has a molecular weight of less than 1000 g/mol as measured by gel permeation chromatography (GPC).

In various embodiments, the single oligoester can be liquid, e.g., a viscous liquid, at 20° C. and 1013 mbar (1 atm). The oligoester composition itself is preferably also liquid.

The oligoester composition described herein can be characterized by its glass transition temperature (Tg). Dynamic mechanical analysis (DMA) and dynamic differential thermal analysis (DSC: differential scanning calorimetry) can be used to determine the Tg values. Preferably, the Tg of the oligoester (composition) can be approximately 50° C. lower than the softening point of the oligoester (composition).

In specific embodiments, the oligoester composition can have a Tg between −80° C. and 100° C., for example −60° C. and 80° C., or between −50° C. and 40° C., or less than approximately 20° C. as measured by DSC.

The oligoester composition can exhibit improved Gardner color. In some embodiments, the oligoester has a pure Gardner color, determined by the method described in ASTM D1544-04 (2010), of 8 or less, for example 6 or less, or 4 or less.

The oligoester composition can exhibit improved color stability. In some embodiments, the oligoester composition can exhibit less than a 10% change, for example less than an 8% change or less than a 5% change, in pure Gardner color as determined according to the method described in ASTM D1544-04 (2010) when heated to a temperature of 160° C. for a period of three hours. In specific embodiments, the pure Gardner color of the oligoester composition, as determined according to the method described in ASTM D1544-04 (2010), remains substantially unchanged (i.e., exhibits less than a 0.5% change in pure Gardner color) when the oligoester composition is heated to a temperature of 160° C. for three hours.

The oligoester composition can also exhibit improved oxidative stability. For example, in some embodiments, when no antioxidant is present in combination with the oligoester composition, the oligoester composition can have a time for onset of oxidation induction at 110° C., as measured using the methods specified in ASTM D5483-05(2010), that is between 30 and 200 minutes, for example between 70 and 150 minutes.

Optionally, the oligoester composition can have a low hydroxyl number. In some embodiments, the oligoester composition has a hydroxyl number of less than 200 mg KOH/gram, for example less than 30 mg KOH/gram, less than 20 mg KOH/gram, or less than 6 mg KOH/gram, measured using a modified version of the standard method given in DIN 53240-2 (a different solvent, tetrahydrofuran, was used). The hydroxyl number is expressed in mg KOH per gram sample of oligoester or oligoester composition.

Optionally, the oligoester composition can have a low acid number. In some embodiments, the oligoester composition has an acid number, determined by the method described in ASTM D465-05 (2010), of 30 mg KOH/gram or less, for example 15 mg KOH/gram or less, or 6 mg KOH/gram or less. The acid number is expressed in mg KOH per gram sample of oligoester or oligoester composition.

Suitable oligoester compositions and their properties are described, for example, in US 2017/0190935 A1.

Various methods can be used to prepare oligoester compositions. For example, the oligoester compositions described here can be prepared by an esterification process in which the carboxylic acid-containing components of the oligoester are esterified with one or more polyhydric alcohols. An esterification reaction of this type is an equilibrium reaction. The removal of water formed during the reaction can shift the reaction equilibrium in favor of product formation and thereby bring the reaction to completion. Accordingly, in some embodiments, methods for preparing oligoesters can comprise esterifying a mixture comprising one or more colophonies, one or more monocarboxylic acids, and optionally one or more polycarboxylic acids with one or more polyhydric alcohols to form the oligoester composition. The esterification step can consist of reacting the mixture and the one or more polyhydric alcohols for a specific period of time and under suitable conditions to form the oligoester. Optionally, the esterification step can also include the removal of water produced as a byproduct of the esterification reaction. Optionally, the esterification step can comprise bringing the mixture and the one or more polyhydric alcohols into contact with an esterification catalyst (e.g., calcium bis(((3,5-bis(1,1-dimethylethyl)-4-hydroxyphenyl)methyl)ethylphosphonate)). In other embodiments, the esterification step can comprise bringing the mixture and the one or more polyhydric alcohols into contact in the absence of an esterification catalyst.

The oligoester compositions described herein can also be prepared by a transesterification process in which esters of the carboxylic acid-containing components of the oligoester are reacted with one or more polyhydric alcohols. In polyhydric alcohols that have reacted with carboxylic acids, it is possible for some free, unreacted hydroxyl groups of the polyhydric alcohol to remain, which can react with the esters in a transesterification reaction and lead to an exchange of their alkoxy groups. Such a transesterification reaction is an equilibrium reaction in which new oligoester compositions can be formed. Accordingly, in some embodiments, methods for preparing oligoester compositions can comprise reacting one or more colophony esters having a hydroxyl value greater than zero with one or more esters derived from monocarboxylic acids and optionally one or more polycarboxylic acids. In some embodiments, an alcohol or polyhydric alcohol can be added to initiate or accelerate such a transesterification reaction. Optionally, the transesterification step can comprise bringing the mixture and the one or more polyhydric alcohols into contact with an esterification catalyst (e.g., calcium bis(((3,5-bis(1,1-dimethylethyl)-4-hydroxyphenyl)methylphosphonate)). In other embodiments, the transesterification step can comprise bringing the mixture and the one or more polyhydric alcohols into contact in the absence of an esterification catalyst. Non-limiting examples of esters of the carboxylic acid-containing components of the oligoester that can be used in such a transesterification process are vegetable oils (e.g., triglyceride vegetable oils) and animal fats and oils, which include oils, such as palm oil, linseed oil, rapeseed oil, sunflower seed oil, olive oil, tung oil, peanut oil, cottonseed oil, palm kernel oil, soybean oil, corn oil, grapeseed oil, hazelnut oil, rice bran oil, safflower oil, sesame oil, butterfat and coconut oil, as well as hydrogenated and deodorized oils. Other esters that can be used in such a transesterification process are colophony esters. Such esters can also be used in the interesterification process described below.

The oligoester compositions described here can also be prepared by an interesterification process that is mechanistically related to esterification and transesterification. Interesterification can be carried out by mixing different esters and subsequent rearrangement of the carboxylic acid groups over the polyhydric alcohol scaffolds used in the presence of a catalyst, e.g., an esterification catalyst. Interesterifications are equilibrium reactions. For example, a colophony ester can be reacted with a triglyceride ester, such as rapeseed oil. Such an interesterification reaction would yield an oligoester in which the fatty acid components in the triglyceride ester are partially substituted by colophony acid components and in which the colophony acid components in the colophony ester are partially substituted by fatty acid components.

The oligoester compositions described herein can also be prepared by a combination of the esterification, transesterification and interesterification processes described above, in which esters can be reacted with one another in the presence of one or more polyhydric alcohols and one or more monocarboxylic acids and optionally one or more polycarboxylic acids or their partial esters or semiesters. An example of partial esters are partial glycerides, i.e., esters of glycerol with fatty acids in which not all hydroxyl groups are esterified. cis-HOOC—CH═CH—COOCH3 is an example of a semiester of maleic acid. Adipic acid monomethyl esters and adipic acid monoethyl esters are examples of semiesters derived from adipic acid. As with the above methods, removal of water or volatile monoalcohols formed during the reaction can shift the reaction equilibrium in favor of product formation and thereby drive the reaction to completion.

For example, in specific embodiments, the preparation methods can comprise esterifying a mixture comprising one or more colophonies, one or more monocarboxylic acids, and optionally one or more polycarboxylic acids, with one or more polyhydric alcohols to form the oligoester composition. In some embodiments, the esterification step can comprise a thermal reaction of the mixture with the one or more polyhydric alcohols. For example, esterification can comprise bringing the mixture into contact with the one or more polyhydric alcohols at an elevated temperature (e.g., at a temperature of from 30° C. to 300° C. or from 150° C. to 285° C.). Optionally, the esterification step can further comprise removing water formed as a by-product during esterification.

In various embodiments, catalysts, co-catalysts, solvents, bleaching agents, stabilizers and/or antioxidants can be added during the esterification, transesterification and interesterification reaction.

The pressure-sensitive adhesive composition according to the invention contains the at least one liquid resin b) which comprises or consists of the oligoester composition, or a combination of such, as described herein, preferably in an amount of 1 to 50 wt. %, more preferably of 2 to 40 wt. %, even more preferably of 5 to 40 wt. %, even more preferably of 5 to 30 wt. %, in particular 10 to 30 wt. %, for example 15 to 30 wt. %, 10 to 25 wt. % or 15 to 20 wt. %, in each case based on the total weight of the pressure-sensitive adhesive composition.

Commercially available pressure-sensitive adhesive compositions usually contain plasticizers. These are used, for example, to reduce the viscosity of the pressure-sensitive adhesive composition and to improve wetting. Common plasticizers used in this context are, for example, medical white oils, naphthenic mineral oils, adipates, polypropylene, polybutylene and polyisoprene oligomers, hydrogenated polyisoprene and/or polybutadiene oligomers, benzoate esters, phthalates, plant or animal oils and the derivatives thereof, sulfonic acid esters, monohydric or polyhydric alcohols and polyalkylene glycols, such as polypropylene glycol, polybutylene glycol or polymethylene glycol. Polybutylene oligomers should have a molecular weight of 200 to 6,000 g/mol, and polyolefins should have a molecular weight Mw of up to approximately 2,000 g/mol, in particular up to 1,000 g/mol.

Oily plasticizer components are often used. Examples of plasticizer components are liquid at room temperature, for example hydrocarbon oils, polybutylene/polyisoprene oligomers, (hydrogenated) naphthenic oils, paraffin oils or plant oils.

The pressure-sensitive adhesive composition according to the invention contains a combination of the described liquid resin b) and at least one further plasticizer c), which comprises an isobutene/butene copolymer. These components are used together to partially, predominantly or completely replace conventional plasticizers, such as those mentioned above. The at least one further plasticizer c) is preferably contained in the pressure-sensitive adhesive composition in an amount of from 0.1 to 30 wt. %, more preferably from 1 to 15 wt. %, for example from 2 to 12 wt. % or 5 to 10 wt. %, based on the total weight of the pressure-sensitive adhesive composition. Particularly preferably, the at least one liquid resin b) and the at least one further plasticizer c) together have a concentration in the pressure-sensitive adhesive composition of 5 to 50 wt. %, preferably 10 to 40 wt. %, in particular 15 to 35 wt. %, based on the total weight of the components of the pressure-sensitive adhesive composition.

The isobutene/butene copolymers used here are synthetic hydrocarbons resulting from polymerization of the C4 fraction. By varying the polymerization parameters, polymers with different chain lengths are created. This variation in chain lengths influences the physical properties.

The at least one further plasticizer c) or the isobutene/butene copolymer can be characterized by its molecular weight. Size-exclusion chromatography (GPC: gel permeation chromatography) can be used to determine the Mn. In various embodiments, the plasticizer c) or the isobutene/butene copolymer has a number-average molecular weight Mn of 750-1450 g/mol, preferably of 850-1350 g/mol, in particular of 900-1300 g/mol. This distinguishes the plasticizer c) used according to the invention from, for example, plasticizer oils, e.g., polybutene oil. Oils typically have a lower number-average molecular weight of, for example, 480 g/mol.

Furthermore, the at least one plasticizer c) or the isobutene/butene copolymer can be characterized by its glass transition temperature (Tg). Dynamic differential thermal analysis (DSC: differential scanning calorimetry) can be used to determine the Tg values. The Tg can be determined according to DIN EN ISO 11357-1:2017-02, -2:2014-07 or -3:2018-07. The glass transition temperature Tg is preferably determined by differential scanning calorimetry (DSC), preferably using a heating rate of 10 K/min. In various embodiments, the plasticizer c) or the isobutene/butene copolymer has a glass transition temperature of −60 to −73° C., more preferably −63 to −73° C., in particular −66 to −70° C.

In various embodiments, the at least one plasticizer c) or the isobutene/butene copolymer has a kinematic viscosity of 0.00018-0.0007 m2/s (180 to 700 cSt), preferably 0.00019 to 0.00067 m2/s (190 to 670 cSt), in particular 0.0002 to 0.000655 m2/s (200 cSt-655 cSt), determined according to ASTM D445 at 100° C.

Suitable isobutene/butene copolymers can be purchased, for example, under the names Polybutene (PB) 1300 from Daelim Industrial or Indopol H300 from Ineos.

It is preferred for the pressure-sensitive adhesive composition to contain no further plasticizers besides the described combination of liquid resin b) and further plasticizer c). Such pressure-sensitive adhesive compositions preferably exhibit improved adhesive strength and/or adherence to various substrates.

In particular, the described liquid resin b) in combination with the at least one further plasticizer c) partially or completely replaces conventional mineral-oil-based plasticizers (e.g., naphthenic oil and/or paraffinic oil) in the pressure-sensitive adhesive composition according to the invention.

Mineral oils are typically produced by the distillation of crude petroleum and optionally other raw fossil materials. Mineral oils include, for example, paraffinic, naphthenic and aromatic hydrocarbons, alkenes and sulfur-containing and nitrogen-containing or organic compounds. The term “naphthenic oil” refers here in particular to saturated cyclic hydrocarbons. “Paraffinic oil” refers in particular to saturated chain hydrocarbons.

In various embodiments, the pressure-sensitive adhesive composition comprises less than 20 wt. %, preferably less than 15 wt. %, more preferably less than 10 wt. %, even more preferably less than 9 wt. %, even more preferably less than 8 wt. %, even more preferably less than 7 wt. %, even more preferably less than 6 wt. %, even more preferably less than 5 wt. %, even more preferably less than 4 wt. %, even more preferably less than 3 wt. %, even more preferably less than 2 wt. %, even more preferably less than 1 wt. %, even more preferably less than 0.5 wt. %, even more preferably less than 0.1 wt. %, even more preferably less than 0.01 wt. %, of mineral-oil-based plasticizers, in particular of naphthenic and/or paraffinic oils, and most preferably is free of these, based on the total weight of the pressure-sensitive adhesive composition.

In a preferred embodiment, the at least one mineral-oil-based plasticizer, preferably the naphthenic and/or paraffinic oil (or the required amount of plasticizer) is replaced in the pressure-sensitive adhesive composition by the at least one liquid resin b) and the at least one further plasticizer c) to a degree of at least 50%, more preferably at least 60%, even more preferably at least 70%, even more preferably at least 80%, even more preferably at least 90%, even more preferably at least 95%, even more preferably at least 98%, even more preferably at least 99%, and most preferably 100%.

In a further preferred embodiment, the pressure-sensitive adhesive composition has a proportion of renewable resources of 20 to 100 wt. %, preferably 50 to 100 wt. %, more preferably of at least 50 wt. %, more preferably of at least 60 wt. %, even more preferably at least 70 wt. %, even more preferably of at least 80 wt. %, even more preferably of at least 90 wt. %, even more preferably of at least 95 wt. %, most preferably of at least 99 wt. %, in each case based on the total weight of the pressure-sensitive adhesive composition.

The pressure-sensitive adhesive composition according to the invention can, in addition to the at least one liquid resin b), further contain at least one further resin d).

Resins are typically used to change, preferably lower, the viscosity of the pressure-sensitive adhesive composition according to the invention and to influence the smell, the (initial) color and the color stability of the composition, and the tackiness and polarity of any polymers present.

These are, in particular, resins which have a softening point of 35 to 160° C. or up to 130° C. (ring-and-ball method, DIN 52011). Suitable resins include, but are not limited to, aromatic, aliphatic or cycloaliphatic hydrocarbon resins, and modified or hydrogenated versions thereof. Specific examples are: aliphatic or alicyclic petroleum hydrocarbon resins and hydrogenated derivatives thereof. Other resins which can be used within the scope of the invention are, for example, hydroabietyl alcohol and the esters thereof, in particular esters having aromatic carboxylic acids, such as terephthalic acid and phthalic acid; modified natural resins, such as resin acids from balsamic resin, tall resin or root resin, for example fully saponified balsamic resin; alkyl esters of optionally partially hydrogenated colophony having low softening points, such as methyl, diethylene glycol, glycerol and pentaerythritol esters; terpene resins, in particular terpolymers or copolymers of terpene, such as styrene terpenes, α-methyl styrene terpenes, phenol-modified terpene resins and hydrogenated derivatives thereof; acrylic acid copolymers, preferably styrene-acrylic acid copolymers and resins based on functional hydrocarbon resins, for example having 3 to 8 carbon atoms, in particular 5 carbon atoms, the at least one resin d) differing from the liquid resin b) described herein, in particular not being liquid resin. Particularly preferably, the at least one resin d) is a solid resin. “Solid”, as used in this context, means that the resin is solid at 20° C. and 1013 mbar, i.e., it is not flowable and does not exist as a liquid with a yield point, but as a solid.

The at least one resin d) is preferably a natural resin or a hydrogenated and/or non-hydrogenated hydrocarbon resin, more preferably a tall oil ester, gum rosin (colophony ester), an optionally partially polymerized tall resin, a terpene or a crude-oil-based aliphatic, aromatic or cycloaliphatic hydrocarbon resin, and modified or hydrogenated versions thereof, for example C5 aliphatic or C9 aromatic hydrocarbon resin or a C5/C9 monomer mixture, the at least one resin d) differing from the liquid resin b) described herein, in particular being not liquid resin but rather, for example, a solid resin.

Particularly preferably, the pressure-sensitive adhesive composition comprises at least one resin d), preferably two resins, in particular selected from colophony esters, for example pentaerythritol esters (from tall oil colophony) and/or (cyclo)aliphatic hydrocarbons, for example having 1 to 30 carbon atoms (aliphatic) or 6 to 30 carbon atoms (cycloaliphatic), e.g., 10 to 25 carbon atoms. The (cyclo)aliphatic hydrocarbons can, in various embodiments, contain a combination of linear, branched, cyclic aliphatic (cycloaliphatic), partially unsaturated or aromatic or heteroaromatic chemical groups and can optionally contain one or more functional groups, such as, but not limited to, a hydroxyl, alkyl, aryl, alkoxy, haloalkyl or keto group. Resins with low coloration and good color stability are particularly suitable.

The solid resins used are preferably distinguished from liquid resins in that they are solid at room temperature (20° C.) and 1013 mbar and have a softening range (ring-and-ball method, ASTM D36, glycerol) between 70 and 110° C., preferably between 85 and 106° C., for example 85 to 100° C.

In a particular embodiment, the at least one resin d) is contained in the pressure-sensitive adhesive composition in an amount of 10 to 70 wt. %, preferably 15 to 60 wt. %, for example of 15 to 70 wt. %, 20 to 50 wt. %, 15 to 45 wt. % or 25 to 60 wt. %, based on the total weight of the composition.

According to the invention, both solid and liquid resins can be used. In preferred embodiments, however, at least one resin d) is a solid resin in addition to the liquid resin b) described herein.

The pressure-sensitive adhesive composition according to the invention can also contain at least one additive e). Suitable additives include, but are not limited to, components from the group consisting of antioxidants, in particular stabilizers, waxes, UV protectors, solvents, adhesion promoters, fillers, pigments, flame retardants, UV absorbers, optical brighteners and fragrances.

The at least one additive e) is preferably contained in the pressure-sensitive adhesive composition in an amount of 0.01 to 20 wt. %, more preferably 0.1 to 5 wt. %, even more preferably 0.5 to 3 wt. %, based on the total weight of the pressure-sensitive adhesive composition.

Antioxidants, such as stabilizers are particularly preferably used in the pressure-sensitive adhesive composition according to the invention, preferably in an amount of 0.01 to 10 wt. %, more preferably 0.1 to 5 wt. %, even more preferably 0.5 to 2 wt. %. They are used, for example, against thermal and oxidative degradation caused by oxygen and UV radiation. In addition, antioxidants can improve heat stability and/or color stability.

When using stabilizers, it must be ensured that they are compatible with the pressure-sensitive adhesive composition. For example, antioxidants that are available under the trade name Irganox® (BASF SE) can be used as stabilizers, preferably in amounts of 0.5 to 1.5 wt. %, for example 1 wt. %, based on the total weight of the composition.

In various embodiments, waxes can optionally be added to the pressure-sensitive adhesive composition in amounts of 0.5 to 5 wt. %. In this case, the amount is measured such that the viscosity is reduced to the desired range while not negatively influencing the adhesion. The wax can be of natural origin, optionally also in chemically modified form, or of synthetic origin. Plant waxes, animal waxes, mineral waxes or petrochemical waxes can be used as natural waxes. Hard waxes, such as montan ester waxes, sasol waxes, etc., can be used as chemically modified waxes. Polyalkylene waxes and polyethylene glycol waxes are used as synthetic waxes. Petrochemical waxes, such as petrolatum, paraffin waxes, microcrystalline waxes and synthetic waxes, are preferably used. Paraffinic and/or microcrystalline waxes and/or hydrogenated versions thereof are particularly preferred, in particular polypropylene or polyethylene wax having a dropping point, determined according to ASTM D-3954, of from 50° C. to 170° C.

The consistency of the pressure-sensitive adhesive composition according to the invention can be adjusted according to the particular requirements, for example by adding suitable solvents. In various embodiments, the pressure-sensitive adhesive composition according to the invention also comprises one or more solvents.

Taking into account the considerable environmental and economic demands associated with the use of in particular organic solvents, it is advantageous, however, to refrain from using solvents. An embodiment is therefore preferred in which the pressure-sensitive adhesive composition according to the invention is free of solvents. The use of solvents can be entirely or partly dispensed with when the amount of liquid resin b) used is selected appropriately.

In a preferred embodiment, the pressure-sensitive adhesive composition according to the invention is solvent-containing, solvent-free or a dispersion.

In a particularly preferred embodiment, the pressure-sensitive adhesive composition comprises
a) at least one polymer, preferably an SBC and/or SIS polymer;
b) at least one liquid resin comprising an oligoester composition, which is a reaction product of a reaction mixture, comprising:
   ii) one or more monocarboxylic acids;
   iii) one or more polyhydric alcohols; and
   iv) optionally one or more polycarboxylic acids,
wherein the reaction mixture comprises one or more colophonies;
c) at least one further plasticizer, wherein the at least one further plasticizer comprises an isobutene/butene copolymer; and
d) at least one resin, preferably two resins, more preferably a colophony ester, such as pentaerythritol resin ester, and/or a (cyclo)aliphatic hydrocarbon resin, for example having 1 to 30 or 6 to 30 carbon atoms, this resin differing from the liquid resin b) described herein, in particular being not a liquid resin, but rather preferably a solid resin;
e) at least one additive, preferably a stabilizer;
wherein the components are preferably used as described below in the pressure-sensitive adhesive composition:
a) 10 to 70 wt. %, preferably 15 to 70 wt. %, more preferably 20 to 70 wt. %, for example 20 to 50 wt. %, 20 to 40 wt. %, 25 to 60 wt. %, 30 to 60 wt. % or 28 to 40 wt. %; and/or
b) 1 to 50 wt. %, preferably 2 to 40 wt. %, more preferably 5 to 40 wt. %, even more preferably 5 to 30 wt. %, in particular 10 to 30 wt. %, for example 15 to 30 wt. %, 10 to 25 wt. % or 15 to 20 wt. %; and/or c) 0.1 to 30 wt. %, more preferably 1 to 15 wt. %, for example 2 to 12 wt. % or 5 to 10 wt. %; and/or d) 10 to 70 wt. %, preferably 15 to 60 wt. %, more preferably 20 to 60 wt. %, for example 15 to 70 wt. %, 15 to 45 wt. %, 20 to 50 wt. %, 40 to 60 wt. % or 25 to 60 wt. %; and/or
e) 0.01 to 20 wt. %, preferably 0.1 to 5 wt. %, more preferably 0.5 to 3 wt. %;
based on the total weight of the pressure-sensitive adhesive composition.

In various embodiments, the pressure-sensitive adhesive composition according to the invention does not contain a betulin-based polyester polyol, as described, for example, in EP3878883A1.

High demands are placed in particular on food packaging and on the substances used to produce said packaging. In addition to the mechanical properties, the focus is in particular on health aspects. Within the scope of the present invention, it has surprisingly been found that, by using a liquid resin b), as described herein, together with at least one plasticizer c), as described herein, the formation of what are referred to as critical migratable cycles can be prevented. Critical migratable cycles are understood to mean compounds which are capable of migrating from the adhesive into the packaging material or the packaged product, for example an item of food, and which thus have the potential to be harmful to health. An embodiment of the pressure-sensitive adhesive composition according to the invention is therefore preferred in which the proportion of critical migratable constituents in the pressure-sensitive adhesive composition is less than 300 ppm, preferably less than 200 ppm, and particularly preferably less than 50 ppm, the ppm indicating proportions by weight and the amounts relating to the total weight of the pressure-sensitive adhesive composition.

In preferred embodiments, the liquid resin b) and/or the plasticizer c) described herein have a molecular weight such that they exhibit only low volatility and thus low migration ability.

Particularly preferably, the liquid resin b) and/or the plasticizer c) described herein contain only components that are approved for contact with food.

In preferred embodiments of the pressure-sensitive adhesive composition according to the invention, the liquid resin b) described herein in combination with the further plasticizers c) described herein partially or completely replaces migratable naphthenic oils or other mineral oils. The liquid resin preferably comprises or consists of an oligoester composition as described herein. Due to the described property of the oligoester composition, there is, in comparison with migratable naphthenic or white medical paraffinic oils, preferably no migration or greatly reduced migration of constituents from the adhesive into materials, such as into packaging materials or into the packaged product, with the liquid resin described herein. This preferably also applies to the at least one plasticizer as described herein.

Furthermore, replacing mineral oils, such as naphthenic oils and/or paraffinic oils, with the liquid resin b) described herein increases the proportion of renewable resources in the formulation.

The pressure-sensitive adhesive composition according to the invention preferably has a lower viscosity compared to other adhesive compositions, as a result of which it can be applied at lower temperatures. This leads to energy and cost savings for the customer.

In a preferred embodiment, the pressure-sensitive adhesive according to the invention has a Brookfield viscosity (e.g., measurable at 20 RPM with spindle 27) at 160° C. of 5,000 to 160,000 mPas, preferably 8,000 to 30,000 mPas, for example 9,000 to 20,000 mPas or 10,000 to 15,000 mPas.

In a preferred embodiment, the softening point of the pressure-sensitive adhesive according to the invention is above 90° C. (ring-and-ball method, ASTM D36, glycerol).

The pressure-sensitive adhesive composition according to the invention preferably has a glass transition temperature Tg of −50 to 80° C., more preferably of −10 to 30° C., in particular of −5 to 20° C., for example 0 to 10° C. (measurement: DMA).

Preferably, the pressure-sensitive adhesive compositions according to the invention have a reduced glass transition temperature, in particular in comparison with compositions with polyester polyols based on betulin.

In preferred embodiments, the pressure-sensitive adhesive composition according to the invention further exhibits improved adhesion to various substrates, for example plastic, glass, non-woven fabric, cardboard or steel, as a result of which preferably a smaller amount of the pressure-sensitive adhesive composition is required in comparison with known pressure-sensitive adhesive compositions.

To check the adherence of the pressure-sensitive adhesive composition according to the invention, a peel test can be carried out. The peel force is typically the average force required to separate two materials stuck together. The test is generally performed at a 90° or 180° angle, depending on the material.

In preferred embodiments, the pressure-sensitive adhesive composition has a peel force of at least 10 Newtons (N) based on a 25 mm wide PET coating using an angle of 180°, measured by the FINAT-FTM1 test method. In other embodiments, the pressure-sensitive adhesive composition according to the invention has a peel force on highly branched (LD) polyethylene of at least 15 N/25 mm PET coating, preferably of at least 18 N/25 mm PET coating, more preferably of at least 20 N/25 mm PET coating, in particular of at least 21 N/25 mm PET coating, for example of at least 22 N/25 mm PET coating. In preferred embodiments, the pressure-sensitive adhesive composition according to the invention has a peel force on non-woven fabric of at least 10 N/25 mm PET coating, preferably of at least 12 N/25 mm PET coating. In further preferred embodiments, the pressure-sensitive adhesive composition has a peel force on cardboard of at least 15 N/25 mm PET coating, preferably of at least 18 N/25 mm PET coating. These measurements all refer to the use of an angle of 180°, measured using the FINAT FTM1 test method.

Furthermore, the adhesive strength of the pressure-sensitive adhesive composition according to the invention can be determined by means of the loop tack test. The determined values refer to a 25 mm×25 mm PET coating.

In preferred embodiments, the pressure-sensitive adhesive composition according to the invention has an adhesive strength (loop tack) on steel of at least 40 N, preferably of at least 43 N, more preferably of at least 45 N, even more preferably of at least 46 N, in particular of at least 47 N. On glass, the pressure-sensitive adhesive composition according to the invention preferably has an adhesive strength of at least 38 N, more preferably of at least 40 N, even more preferably of at least 42 N and in particular of at least 43 N. In preferred embodiments, the composition has an adhesive strength on LD polyethylene of at least 20 N, preferably of at least 22 N, in particular of at least 23 N.

The present invention further relates to a method for preparing the pressure-sensitive adhesive composition according to the invention, comprising mixing the at least one liquid resin b), as described herein, with further components of the pressure-sensitive adhesive composition, such as the at least one polymer a) and the at least one further plasticizer c) and optionally further components, such as at least one resin d) and/or at least one additive e), in a suitable order;
preferably at a temperature of 100 to 200° C., more preferably at 120 to 180° C., even more preferably at 150 to 170° C.

In a preferred embodiment, the further components of the pressure-sensitive adhesive composition, such as polymer a) and resin d), are first provided and mixed before the liquid resin b) is added. Afterwards the plasticizer c) or additives e) can be added.

A preferred mixing sequence for the method for preparing the pressure-sensitive adhesive composition according to the invention is:
1. Providing at least one polymer a),
2. Optionally adding at least one resin d), preferably two resins,
3. Adding the at least one liquid resin b) as described herein,
4. Adding at least one plasticizer c),
5. Optionally adding at least one additive, for example at least one stabilizer,
   preferably at a temperature of 100 to 200° C., more preferably at 120 to 180° C., even more preferably at 150 to 170° C.

Preferably, the individual components for preparing the pressure-sensitive adhesive composition according to the invention are as described herein.

The present invention also relates to the use of the pressure-sensitive adhesive composition according to the invention in tapes, labels, hygiene articles, such as diapers, labeling, e.g., of beverage bottles, flexible packaging, films, food packaging, in the field of assembly (high performance, such as in the automotive industry), medical applications (e.g., in packaging for medical materials and products), and/or in the graphics industry (e.g., books, magazines, brochures).

The pressure-sensitive adhesives according to the invention are used, for example, for bonding substrates, such as glass, metal, for example steel, woven fabrics, non-wovens, coated or uncoated paper, cardboard and plastics materials, such as PET, PEN, PE, PP, PVC and PS. Thin flexible substrates, for example made of films, multi-layer films or paper, are then glued to solid substrates of this type. Said thin flexible substrates are, for example, labels, outer packaging, bags, etc., and can be made, for example, from plastics materials, for example from polyethylene, polypropylene, polystyrene, polyvinyl chloride or cellophane, in particular from PE films. However, the labels can also be based on paper, optionally in combination with polymer films. The hot-melt pressure-sensitive adhesives according to the invention are distinguished in particular by very good adhesion to the aforementioned plastics materials, although they can also be removed from the substrate surfaces again.

Further fields of application are described, for example, in the international patent publication WO 2016/062797 A1, in particular on pages 10-11.

In a preferred embodiment, the amount of pressure-sensitive adhesive composition applied is 1 to 200 g/m2, preferably 2 to 70 g/m2, more preferably 10 to 60 g/m2, for example 20 to 50 g/m2.

In a preferred embodiment, the substrates can optionally be subjected to a pretreatment and/or the two substrates are joined together under pressure.

The present invention further relates to an article comprising the pressure-sensitive adhesive composition according to the invention. In a preferred embodiment, the article can be obtained using the method according to the invention. The article is preferably a multi-layered substrate, in particular for packaging for food and pharmaceutical products, for hygiene articles, in the field of “labels” and “labeling,” but also for use in the automotive industry or the graphics industry.

All aspects, objects and embodiments described for the pressure-sensitive adhesive composition according to the invention can also be applied to the methods according to the invention, the article according to the invention, and the use according to the invention. Therefore, reference is expressly made at this juncture to the disclosure at the corresponding point when it was indicated that this disclosure also applies to the use according to the invention, the article according to the invention and the methods according to the invention.

The invention is described in the following with reference to examples, but is not limited to these examples.

### EXAMPLES

### Example 1

The preparation of a pressure-sensitive adhesive with liquid resin, comprising an oligoester composition as described herein:

The raw materials listed were formulated according to the mixing sequence listed in the table below at the specified temperature. The adhesive was mixed with a propeller mixer at speeds of 50-500 rpm.

TABLE 1
Formulation 1

| | | | | Mixing |
|---|---|---|---|---|
| Raw material type | Trade name | Wt. % | Weight in g | temperature |
| SBC polymer | Vector 4186 ¹ | 30 | 60 | 160° C. |
| Resin 1 | Sylvalite RE 100s² | 28 | 56 | |
| Resin 2 | Escorez 5400³ | 15 | 30 | |
| Liquid resin with | For example, | 17.5 | 35 | |
| oligoester composition | sample 28 | | | |
| | according to US | | | |
| | 2017/0190935 A1 | | | |
| Polybutene | Polybutene PB | 8 | 16 | |
| | 1300 | | | |
| Stabilizer | Irganox B225⁴ | 1 | 2 | |

¹ radial styrenic block copolymer with narrow molecular weight distribution, available from TSRC Corporation, USA
²stabilized pentaerythritol ester of tall oil colophony, available from Kraton Corporation, USA
³cycloaliphatic hydrocarbon resin, available from ExxonMobil, USA
⁴mixture of phenolic antioxidant (Irganox ® 1010) and a secondary phosphite antioxidant (Irgafos@ 168), available from BASF, Germany.

The adhesive according to the invention has increased adhesion to various substrates while reducing the application weight. This means that significantly less adhesive can be used to meet the requirements of the application in comparison with reference adhesive 1. This leads to energy and cost savings for the customer.

TABLE 2
Physical properties

| | Mineral-oil-free | Mineral-oil-free | |
|---|---|---|---|
| | pressure-sensitive | pressure-sensitive | |
| | adhesive with | adhesive with liquid | |
| | polyester polyol based | resin with oligoester | |
| | on betulin | composition | Reference 1 |
| Method | (EP3878883A1) | (formulation 1) | Technomelt 8746 |
| Brookfield viscosity | 140° C.: 12,300 | 140° C.: 27,350 | 140° C.: 26,500 |
| (20 RPM with | 160° C.: 9,200 | 160° C.: 12,930 | 160° C.: 11,425 |
| spindle 27) in mPas | | | |
| Softening point | 110.2 | 91.3 | 98.0 |
| in ° C. (ring-and-ball, | | | |
| ASTM D36, | | | |
| glycerol) | | | |
| Tg (DMA) in ° C. | 6.9 | 6.3 | 7.9 |
| Crossover (DMA) | 89.5 | 81.2 | 86.1 |
| in °C. | | | |

The coatings required to carry out the adhesion tests are produced on a laboratory scale on a heatable coating table. This table has a heated and movable doctor blade that can be used to draw the adhesive across the table. The layer thickness is set using two adjusting screws for rough adjustment and two adjusting screws for fine adjustment. The gap width between the doctor blade and the heating plate is displayed by means of two manometers, which rest on the doctor blade above the adjusting screws. Here, the gap width in micrometers can be read off a scale. The adhesive is applied to silicone paper, which is fixed to the plate by a vacuum. After the adhesive layer has been applied, it is rolled onto a PET film. After checking the application weight with a maximum deviation of ±10% and a rest period of 24 hours, the finished coating can be used for the test. The coatings were made with a 50 μm thick PET film and an application weight of 40 g/m².

The following table provides 180° peel and loop tack adhesion values on various substrates. The mineral-oil-free adhesive according to the invention with liquid resin comprising an oligoester composition, as described herein, exhibits improved values in comparison with the mineral-oil-free pressure-sensitive adhesive with polyester polyol based on betulin (EP3878883A1) and is comparable to a good label and all-rounder pressure-sensitive adhesive (Reference 1).

TABLE 3
Adhesive properties

| | | Mineral-oil-free | Mineral-oil-free | |
|---|---|---|---|---|
| | | pressure- | pressure- | |
| | | sensitive | sensitive | |
| | | adhesive with | adhesive with | |
| | | polyester polyol | liquid resin with | |
| | | based on betulin | oligoester | Reference 1 |
| Method | Substrate | (EP3878883A1) | composition | Technomelt 8746 |
| Peel test 180° | Steel (after 20 | 34N | 40N | 39N |
| (FINAT-FTM1) | min) | | | |
| based on 25 mm | Steel (after 24 | 33N | 40N | 36N |
| wide PET | hr) | | | |
| coating | LD | 20N | 22N | 19N |
| | polyethylene | | | |
| | (after 20 min) | | | |
| | LD | 19N | 22N | 17N |
| | polyethylene | | | |
| | (after 24 hr) | | | |
| | Non-woven | 13N | 12N | 12N |
| | fabric (after 20 | | | |
| | min) | | | |
| | Cardboard | 18N | 18N | 17N |
| Loop tack based | Steel | 44N | 46N | 47N |
| on 25 mm × | Glass | 43N | 43N | 34N |
| 25 mm PET | LD | 15N | 23N | 24N |
| coating | polyethylene | | | |

1. A pressure-sensitive adhesive composition comprising
a) at least one polymer;
b) at least one liquid resin comprising an oligoester composition, which is a reaction product of a reaction mixture, comprising:
ii) one or more monocarboxylic acids;
iii) one or more polyhydric alcohols; and
iv) optionally one or more polycarboxylic acids,
wherein the reaction mixture comprises one or more colophonies;
c) at least one further plasticizer, wherein the at least one further plasticizer comprises an isobutene/butene copolymer;
d) optionally at least one further resin; and
e) optionally at least one additive.

2. The pressure-sensitive adhesive composition according to claim 1, wherein the at least one polymer a) is selected from the group of polymers based on acrylate, polyester, urethane, ethylene acrylate, butyl rubber and (synthetic) natural rubber; ethylene-vinyl acetate copolymers (EVA), polyolefin (co)polymers (PO), polyamide (co)polymers (PA), ethylene-propylene copolymers or styrene copolymers, individually or as a mixture, said polymer is present in 20 to 70 wt. %, based on the total weight of the composition.

3. The pressure-sensitive adhesive composition according to claim 1, wherein the reaction mixture for preparing the oligoester composition comprises
25 wt. % to 85 wt. % of one or more monocarboxylic acids,
7 wt. % to 35 wt. % of one or more polyhydric alcohols, and
more than 0 wt. % to less than 4 wt. % of one or more polycarboxylic acids, wherein the reaction mixture contains 5 wt. % to 75 wt. % colophony.

4. The pressure-sensitive adhesive composition according to claim 3, wherein the colophony comprises a mixture of colophony acids, selected from the group consisting of abietic acid, neoabietic acid, dehydroabietic acid, dihydroabietic acid, pimaric acid, levopimaric acid, sandaracopimaric acid, isopimaric acid and palustric acid and their isomers.

5. The pressure-sensitive adhesive composition according to claim 1, wherein the at least one liquid resin b) is contained in the pressure-sensitive adhesive composition in an amount of 5 to 30 wt. %, based on the total weight of the pressure-sensitive adhesive composition.

6. The pressure-sensitive adhesive composition according to claim 1, wherein the at least one further plasticizer c)
i) is contained in an amount of 1 to 15 wt. %, based on the total weight of the pressure-sensitive adhesive composition; and/or
ii) has a number-average molecular weight Mₙ of 900-1300 g/mol, measured by size-exclusion chromatography (GPC, gel permeation chromatography); and/or
iii) has a glass transition temperature (Tg) of −60 to −73° C. measured by dynamic differential thermal analysis (DSC: differential scanning calorimetry); and/or
iv) has a kinematic viscosity of 0.00018-0.0007 m²/s (180 to 700 cSt), determined according to ASTM D445 at 100° C.

7. The pressure-sensitive adhesive composition according to claim 1, wherein the pressure-sensitive adhesive composition comprises no further plasticizers besides the isobutene/butene copolymer plasticizer c).

8. The pressure-sensitive adhesive composition according to claim 1, wherein the at least one further resin d) is a solid and is selected from the group consisting of a a tall oil ester, a gum rosin (colophony ester), a partially polymerized tall resin, a terpene, a crude-oil-based aliphatic, aromatic or cycloaliphatic hydrocarbon resin, a C5 aliphatic or C9 aromatic hydrocarbon resin, and a C5/C9 monomer mixture, which is present in an amount of 15 to 60 wt. %, based on the total weight of the pressure-sensitive adhesive composition.

9. The pressure-sensitive adhesive composition according to claim 1, wherein the at least one further resin d) comprises at least two further resins, wherein the resins are selected from solid (cyclo)aliphatic hydrocarbons and/or solid colophony esters.

10. The pressure-sensitive adhesive composition according to claim 1, wherein the at least one additive e) comprises at least one substance from the group consisting of antioxidants, such as stabilizers, waxes, UV protectors, solvents, adhesion promoters, fillers, pigments, flame retardants, UV absorbers, optical brighteners and fragrances, which is present in an amount of 0.01 to 20 wt. %, based on the total weight of the pressure-sensitive adhesive composition.

11. A method for preparing the pressure-sensitive adhesive composition according to claim 1, comprising mixing at least one liquid resin b) with at least one polymer a) and the at least one further plasticizer c) and resin d) and/or at least one additive e), in a suitable order; at a temperature of 100 to 200° C.

12. The pressure-sensitive adhesive composition according to claim 1, which is a prepared as a tape, label or package.

13. An article comprising the tape, label or package of the claim 12.

14. A method for bonding at least two substrates, wherein the pressure-sensitive composition according to claim 1 is applied to at least one substrate and the at least two substrates are subsequently joined together.

15. The article of claim 13, which a diaper, beverage bottle, flexible package, food package, cardboard box, envelope, automobile books, magazines or brochures.
